(19) United States
(12) Patent Application Publication
(10) Pub. No.: US 2006/0083959 A1
(43) Pub. Date: Apr. 20, 2006

(54) Polymer electrolyte fuel cell cartridge and polymer electrolyte fuel cell

(75) Inventors: Shinji Eritate, Kawasaki-shi (JP); Motokazu Kobayashi, Yokohama-shi (JP); Makoto Kubota, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki kaisha, Tokyo (JP)

(21) Appl. No.: 11/246,104

(22) Filed: Oct. 11, 2005

(30) Foreign Application Priority Data
Oct. 14, 2004 (JP) 2004-300686

(51) Int. Cl. H01M 8/00

(52) U.S. Cl. 429/12

(57) ABSTRACT

There is provided a polymer electrolyte fuel cell cartridge for supplying a fuel and an oxidizer to a polymer electrolyte fuel cell, including at least two chambers in which: one chamber stores the fuel; and the other chamber stores the oxidizer. The fuel includes one of hydrogen and an aqueous methanol solution, and the oxidizer includes at least one of oxygen, air, ozone, and hydrogen peroxide. There is provided a polymer electrolyte fuel cell including the polymer electrolyte fuel cell cartridge connected thereto, to thereby provide more stable power output.

### BACKGROUND OF THE INVENTION

1. Field of the Invention

The present invention relates to a polymer electrolyte fuel cell cartridge, and to a polymer electrolyte fuel cell.

2. Related Background Art

A polymer electrolyte fuel cell has a layered structure in which a polymer electrolyte membrane is held between a fuel electrode and an oxidizer electrode. The fuel electrode and the oxidizer electrode are each composed of a mixture of: a catalyst having a noble metal such as platinum or an organometallic complex carried on conductive carbon; an electrolyte; and a binder. A fuel supplied to the fuel electrode passes through fine pores of the electrode, reaches the catalyst, and releases electrons by the action of the catalyst to convert into hydrogen ions. The hydrogen ions pass through the electrolyte membrane provided between the electrodes, reach the oxidizer electrode, and react with oxygen in air supplied to the oxidizer electrode and electrons flowing from an external circuit into the oxidizer electrode, to thereby produce water. The electrons released from the fuel pass through the catalyst and the conductive carbon carrying the catalyst in the electrode, are guided to the external circuit, and flow into the oxidizer electrode from the external circuit. As a result, in the external circuit, the electrons flow from the fuel electrode to the oxidizer electrode such that electric power is taken out.

In other words, when hydrogen is used as a fuel, for example, the following reaction occurs at the fuel electrode.
H₂→2H⁺+2e⁻

In addition, the following reaction occurs at the oxidizer electrode.
½O₂+2H⁺+2e⁻H₂O

There has been developed a fuel cell such as a direct methanol fuel cell (DMFC) which operates by directly supplying an organic fuel such as methanol or dimethyl ether to a fuel electrode without reforming the organic fuel. Such a fuel cell requires no reformer for reforming the organic fuel such as methanol into a hydrogen-rich reformed gas, and thus has a simple structure and is expected to be used as a power source for a portable device or a vehicle.

Theoretically, the fuel cell has high electricity generation efficiency because free energy change in a chemical reaction is taken out directly as an electrical energy. The fuel cell has attracted attention as an environmentally friendly power source which contributes to reduction of carbon dioxide emissions.

There are proposed fuel cell systems in which a fuel is stored in a replaceable cartridge to allow continuous electricity generation from the fuel supplied from the cartridge (see Japanese Patent Application Laid-Open No. 2003-331879 and Japanese Patent Application Laid-Open No. 2003-346836).

However, the conventional examples had disadvantages as described below. In Japanese Patent Application Laid-Open No. 2003-331879 and Japanese Patent Application Laid-Open No. 2003-346836, oxygen serving as an oxidizer is naturally sucked air, or air supplied by a forcible air blower mechanism such as a fan or a pump for accelerating air diffusion.

Air supplied from outside of the fuel cell contains air pollutants such as nitrogen oxides or sulfur oxides in trace amounts. Such impurities accumulate in an electrolyte membrane, an oxidizer electrode, a fuel electrode, or the like, and cause deterioration in conductivity of a polymer electrolyte or deterioration in activity of a catalytic reaction. As a result, fuel cell performance gradually deteriorates in an operation of the fuel cell over a long period of time. Sulfur oxides may poison a catalyst to deteriorate the fuel cell performance, and nitrogen oxides may corrode and deteriorate members of the fuel cell. Thus, a conventional fuel cell may not provide stable power output over a long period of time.

### SUMMARY OF THE INVENTION

An object to be achieved by the present invention is to provide a cartridge used for a polymer electrolyte fuel cell providing stable power output regardless of use environment. Another object of the present invention is to provide a polymer electrolyte fuel cell including the cartridge connected thereto.

According to one aspect of the present invention, a polymer electrolyte fuel cell cartridge for supplying a fuel and an oxidizer to a polymer electrolyte fuel cell includes at least two chambers in which: one chamber stores the fuel; and the other chamber stores the oxidizer.

In further aspect of the polymer electrolyte fuel cell cartridge, the fuel includes one of hydrogen and an aqueous methanol solution; and the oxidizer includes at least one of oxygen, air, ozone, and hydrogen peroxide.

According to another aspect of the present invention, a polymer electrolyte fuel cell includes the polymer electrolyte fuel cell cartridge connected thereto.

The present invention provides a polymer electrolyte fuel cell cartridge providing stable power output by using a cartridge including at least two chambers in which: one chamber stores the fuel; and the other chamber stores the oxidizer.

Further, the present invention provides a polymer electrolyte fuel cell employing the polymer electrolyte fuel cell cartridge. In the fuel cell of the present invention, not only the fuel but also the oxidizer is supplied from the cartridge, and thus the fuel cell is not affected by outside air and can be used in various environments. In the present invention, an oxidizer except air can be used, to thereby allow high power output.

Other features and advantages of the present invention will be apparent from the following description taken in conjunction with the accompanying drawings.

### BRIEF DESCRIPTION OF THE DRAWINGS

FIG. 1 is a schematic diagram showing an example of a polymer electrolyte fuel cell cartridge according to the present invention;

FIG. 2 is a schematic diagram showing an example of a polymer electrolyte fuel cell according to the present invention; and

FIG. 3 is a schematic sectional view showing an example of an electricity generation part according to the present invention.

### DESCRIPTION OF THE PREFERRED EMBODIMENTS

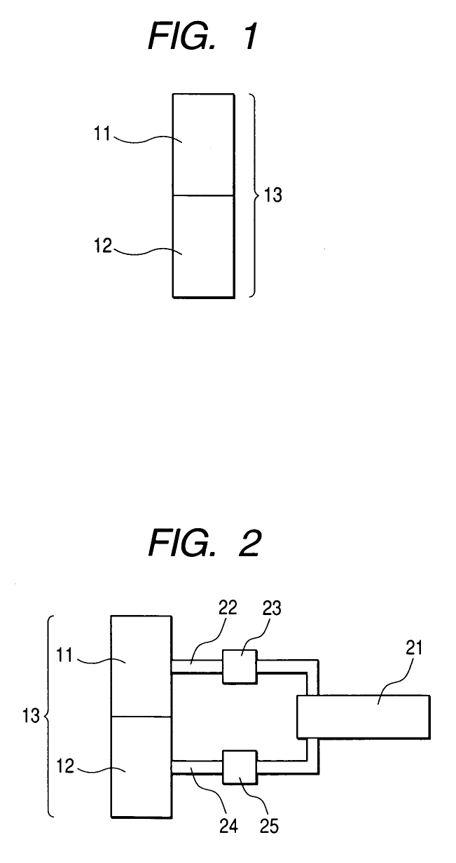

Hereinafter, embodiments of the present invention will be described in more detail. FIG. 1 shows a partial schematic view of an example of a polymer electrolyte fuel cell cartridge (hereinafter, abbreviated as cartridge) according to the present invention.

In FIG. 1, the cartridge includes at least two chambers, that is, a fuel storage chamber 11 and an oxidizer storage chamber 12. In FIG. 1, the fuel storage chamber 11 and the oxidizer storage chamber 12 are formed integrally into a cartridge 13. After fuel or oxidizer consumption, the cartridge 13 alone may be removed and replaced with a new cartridge for repeated use of the cartridge. The cartridge 13 used in the present invention is formed into a shape of a cylinder or a rectangular parallelepiped by using a material which is not decomposed by the fuel or the oxidizer. Examples of the material include a hard resin, a metal, and glass. To be specific, a polymer such as polyethylene may be used.

Alternatively, the fuel storage chamber 11 and the oxidizer storage chamber 12 may be formed independently to be independently removable from the cartridge. Thus, after consumption of the fuel or the oxidizer, one chamber may be replaced with a new chamber.

Examples of the fuel stored in the fuel storage chamber 11 include hydrogen and an organic fuel. Examples of the organic fuel include: an alcohol such as methanol, ethanol, propanol, or ethylene glycol; and an ether such as dimethyl ether or diethyl ether.

In a case where hydrogen is used as a fuel, gasified or liquefied hydrogen filled into a gas cylinder may be used as a hydrogen source, or hydrogen may be stored by using a hydrogen storage alloy or a carbonaceous hydrogen storage material. Examples of the hydrogen storage alloy that can be used include: a magnesium-based hydrogen storage alloy; a titanium-based or zirconium-based hydrogen storage alloy; a rare earth-based hydrogen storage alloy; and a lanthanum/nickel/aluminum-based or a misch metal/nickel/aluminum-based hydrogen storage alloy. The carbonaceous hydrogen storage material is not particularly limited, but examples thereof that can be preferably used include fullerene, carbon nanofiber, carbon nanotube, carbon soot, nanocapsule, bucky onion, and carbon fiber.

In a case where the organic fuel is used as a fuel, a liquid fuel may be stored in a small liquid fuel storage vessel. The liquid fuel storage vessel may be formed of a hard resin, a metal, or glass, for example. To be specific, a polymer such as polyethylene can be used.

Examples of the oxidizer to be stored in the oxidizer storage chamber 12 include: a gas such as oxygen, air, or ozone; and a liquid such as hydrogen peroxide. In a case where the gas is used as an oxidizer, a gasified or liquefied gas may be filled into a gas cylinder and stored. In a case where the liquid is used as an oxidizer, the oxidizer may be stored in a small liquid oxidizer storage vessel. The liquid oxidizer storage vessel may be formed of a hard resin, a metal, or glass, for example. To be specific, a polymer such as polyethylene can be used.

In this case, pressures inside the fuel storage chamber 11 and the oxidizer storage chamber 12 reduce as volumes of the fuel and the oxidizer reduce, respectively. Thus, in order to maintain the pressures inside the fuel storage chamber 11 and the oxidizer storage chamber 12 higher than a pressure inside an electricity generation part until the fuel and the oxidizer are completely consumed, an inert gas such as nitrogen or argon may be filled into the fuel storage chamber 11 and the oxidizer storage chamber 12 in advance to increase the pressures thereinside. In this way, the fuel and the oxidizer can be consumed completely.

Alternatively, movable partition walls may be provided inside the fuel storage chamber 11 and the oxidizer storage chamber 12. The pressures inside the fuel storage chamber 11 and the oxidizer storage chamber 12 may be increased by filling an inert gas such as nitrogen or argon thereinto or by using an elastic body such as a spring.

A polymer electrolyte fuel cell shown in FIG. 2 is provided with: the cartridge 13 including the fuel storage chamber 11 and oxidizer storage chamber 12 formed integrally; an electricity generation part 21; a fuel supply tube 22 for supplying a fuel from the fuel storage chamber 11 to the electricity generation part 21; a fuel supply part 23 composed of a pump, for example; an oxidizer supply tube 23 for supplying an oxidizer from the oxidizer storage chamber 12 to the electricity generation part 21; and an oxidizer supply part 25 composed of a pump, for example.

Such a structure allows supply of the fuel and the oxidizer from the cartridge to the electricity generation part. The polymer electrolyte fuel cell shown in FIG. 2 is provided with the fuel supply part 23 and the oxidizer supply part 25 each composed of a pump, for example, but the fuel supply part 23 and the oxidizer supply part 25 may not be included in the structure of the polymer electrolyte fuel cell according to the present invention. In this case, the fuel supply tube 22 and the oxidizer supply tube 24 are each preferably formed of a narrow tube allowing capillary action. Alternatively, a porous member such as polyurethane, polyester, cellulose, a phenol-based resin, polypropylene, or glass fiber may be filled into each of the fuel supply tube 22 and the oxidizer supply tube 24 for aiding supply of the fuel and the oxidizer.

The polymer electrolyte fuel cell may have a structure (not shown in FIG. 2) in which the supplied fuel and the supplied oxidizer pass through the electricity generation part, pass through discharge tubes of the fuel and the oxidizer, respectively, and return to the cartridge, to thereby allow repeated use of the fuel and the oxidizer.

Further, in a case where a pressure inside the fuel cell increases due to reaction products or the like of the fuel and the oxidizer, an internal pressure regulating device such as a valve for regulating a pressure may be provided in the fuel storage chamber 11, the oxidizer storage chamber 12, or the like of the cartridge (not shown in FIG. 2).

The electricity generation part 21 includes a unit cell obtained by holding an electrolyte membrane between a fuel electrode and an oxidizer electrode. In this case, a fuel cell stack obtained by stacking a plurality of unit cells may be used, or a fuel cell having a structure obtained by connecting a plurality of unit cells in series or parallel in a plurality of planes may be used. Note that, the fuel electrode and the oxidizer electrode each include a gas diffusion layer and an electrode catalyst layer.

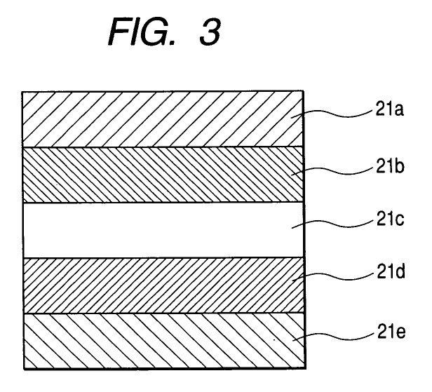

FIG. 3 shows an example of a structure of a unit cell. As shown in FIG. 3, the unit cell is provided with: a gas diffusion layer 21a and an electrode catalyst layer 21b on a fuel electrode side; an electrolyte membrane 21c; and an electrode catalyst layer 21d and a gas diffusion layer 21e on an oxidizer electrode side. In FIG. 2, the fuel supply tube 22 is connected to the fuel electrode side of the electricity generation part 21, and the oxidizer supply tube 24 is connected to the oxidizer electrode side of the electricity generation part 21.

A perfluorosulfonic acid polymer membrane represented by a Nafion membrane (available from DuPont), a hydrocarbon-based membrane (available from Hoechst AG), or the like is preferably used as the electrolyte membrane 21c. However, the membrane used for the electrolyte membrane 21c is not limited to those described above. A polymer membrane having a functional group with hydrogen ion conductivity such as a sulfonic acid group, a sulfinic acid group, a carboxylic acid group, a phosphonic acid group, a phosphoric acid group, or a boronic acid may be used generally.

Further, a hybrid electrolyte membrane of an inorganic electrolyte and a polymer membrane prepared through a sol gel method may be used. Carbon powder carrying a noble metal catalyst is used for the electrode catalyst layers 21b and 21d. For example, a platinum/ruthenium alloy is used as a noble metal catalyst on the fuel electrode side, and platinum is used as a noble metal catalyst on the oxidizer electrode side.

Alternatively, an electrode catalyst is mixed with a binder, a polymer electrolyte, a water repellant, conductive carbon, a solvent, or the like to be used for the electrode catalyst layer. The electrode catalyst layer 21b on the fuel electrode side is provided in contact with the gas diffusion layer 21a. In the present invention, a laminate of the electrode catalyst layer 21b and the gas diffusion layer 21a are collectively referred to as a fuel electrode.

The electrode catalyst layer 21d on the oxidizer electrode side is provided in contact with the gas diffusion layer 21e. In the present invention, a laminate of the electrode catalyst layer 21d and the gas diffusion layer 21e are collectively referred to as an oxidizer electrode. The gas diffusion layers 21a and 21e allow: efficient and uniform introduction of hydrogen, reformed hydrogen, methanol, or dimethyl ether as a fuel, and air or oxygen as an oxidizer into the respective electrode-catalyst layers; and contact with the respective electrodes for transfer of electrons.

In general, a conductive porous membrane such as carbon paper, carbon cloth, or a composite sheet of carbon and polytetrafluoroethylene is preferably used for the gas diffusion layers 21a and 21e. The surface and inside of each of the gas diffusion layers 21a and 21e may be coated with a fluorine-based paint for water repellent treatment for use.

The fuel cell according to the present invention is produced by stacking the polymer electrolyte membrane, the electrode catalyst layers, and the gas diffusion layers as shown in FIG. 3. However, the fuel cell may have an arbitrary shape and may be produced through a general method without particular limitation.

### EXAMPLES

Fuel cells were produced through the following procedure and used for tests.

(Electrolyte Membrane)

Nafion 112 (available from DuPont) was used.

(Production of Electrode Catalyst Layer)

Carbon paper (TGP-H-30, available from Toray Industries, Ltd.) having a thickness of 0.1 mm and subjected to water repellant treatment was used as a gas diffusion layer on a fuel electrode side. A paste prepared by sufficiently mixing 1 g of carbon (available from Tanaka Kikinzoku Kogyo) carrying a Pt—Ru catalyst (60 wt %, Pt:Ru=1:1, atomic ratio), and 5 g of a 5 wt % Nafion solution (available from Aldrich-Sigma Japan K.K.) was used for an electrode catalyst layer on the fuel electrode side. The catalyst paste was applied on the carbon paper to a predetermined thickness by using a bar coater, and the resultant was dried under reduced pressure. An amount of the carried catalyst was 5 mg/cm².

Carbon paper subjected to water repellent treatment was also used for a gas diffusion layer on an oxidizer electrode side. A paste prepared by sufficiently mixing 1 g of carbon (available from Tanaka Kikinzoku Kogyo) carrying a Pt catalyst (60 wt %), and 5 g of a 5 wt % Nafion solution was used for an electrode catalyst layer on the oxidizer fuel electrode side. The catalyst paste was applied on the carbon paper to a predetermined thickness by using a bar coater, and the resultant was dried under reduced pressure. An amount of the carried catalyst was 5 mg/cm².

(Production of Membrane Electrode Assembly)

Electrode catalyst layer-attached carbon papers as the fuel electrode and the oxidizer electrode were arranged on both sides of the polymer electrolyte membrane, and the whole was subjected to hot pressing at 90° C. and 9.8 MPa for 10 min, to thereby obtain a membrane electrode assembly. An electrode surface area of each of the fuel electrode and the oxidizer electrode was 2 cm×2 cm. The membrane electrode assembly obtained through the above-mentioned procedure was held between separators as current collectors, to thereby produce a unit cell.

(Fuel Cell Test)

The fuel storage chamber 11 inside the cartridge 13 formed of an acrylic resin was filled with 10 mL of an aqueous methanol solution (methanol concentration of 5 wt %) or 30 mL of a hydrogen gas (25° C., 0.2 MPa). The oxidizer storage chamber 12 was filled with 30 mL of an oxygen gas (25° C., 0.2 MPa) or 30 mL of air (25° C., 0.2 MPa).

A flow rate of the aqueous methanol solution as a fuel was 2 mL/min by using a pump of the fuel supply part 23. In the oxidizer supply part 25, no pump was used for forcible supply of the oxidizer. Stainless steel tubes were used for the fuel supply tube and the oxidizer supply tube.

Fuel cell properties were measured and power output stability of the fuel cell was evaluated by: placing the fuel cell into a sealed vessel filled with air containing 0.03 ppm of NO₂ and 0.005 ppm of SO₂; and using a fuel cell evaluation apparatus (manufactured by TOYO Corporation). NO₂ and SO₂ concentrations were evaluated by referring to NO₂ and SO₂ concentrations monitored by roadside air pollution monitoring stations (416 stations) throughout Japan as of the end of FY 2000 of air pollutant measurement items monitored by prefectures and the ordinance-designated cities in accordance with the Air Pollution Control Law.

The fuel cell was electrically discharged at a current density of 50 mA/cm², and the electrical discharge was continued by replacing the cartridge with a new cartridge when the fuel or the oxidizer was completely consumed and a terminal voltage reduced. In Comparative Examples 1 and 2, the oxidizer supply tube 24 was detached from the electricity generation part 21, for testing in open air.

Table 1 shows an initial terminal voltage and a terminal voltage 6 months after electrical discharge at 50 mA/cm² for 7 hours per day.

TABLE 1

| | | | Initial | Terminal |
|---|---|---|---|---|
| | | | terminal | voltage after |
| | Fuel | Oxidizer | voltage (V) | 6 months (V) |
| Example 1 | Hydrogen | Oxygen | 0.53 | 0.43 |
| Example 2 | Aqueous | Air | 0.30 | 0.21 |
| | methanol | | | |
| | solution | | | |
| Comparative | Hydrogen | Open air | 0.42 | 0 |
| Example 1 | | | | |
| Comparative | Aqueous | Open air | 0.30 | 0 |
| Example 2 | methanol | | | |
| | solution | | | |

The results of Table 1 clearly show that the fuel cell including the polymer electrolyte fuel cell cartridge of the present invention connected thereto exhibited stable voltages. In contrast, fuel cell performance of the fuel cell of Comparative Examples significantly deteriorated.

As described above in detail, the present invention provides the polymer electrolyte fuel cell cartridge for supplying the fuel and the oxidizer to the polymer electrolyte fuel cell, including at least two chambers in which: one chamber stores the fuel; and the other chamber stores the oxidizer. The polymer electrolyte fuel cell cartridge can be used for a polymer electrolyte fuel cell, to thereby provide stable power output regardless of use environment.

This application claims priority from Japanese Patent Application No. 2004-300686 filed on Oct. 14, 2004, which is hereby incorporated by reference herein.

What is claimed is:

1. A polymer electrolyte fuel cell cartridge for supplying a fuel and an oxidizer to a polymer electrolyte fuel cell, comprising at least two chambers wherein:
one chamber stores the fuel; and
the other chamber stores the oxidizer.

2. The polymer electrolyte fuel cell cartridge according to claim 1, wherein:
the fuel comprises one of hydrogen and an aqueous methanol solution; and
the oxidizer comprises at least one of oxygen, air, ozone, and hydrogen peroxide.

3. The polymer electrolyte fuel cell cartridge according to claim 1, wherein at least one of the two chambers further stores an inert gas.

4. A polymer electrolyte fuel cell, comprising a polymer electrolyte fuel cell cartridge connected thereto for supplying a fuel and an oxidizer to the polymer electrolyte fuel cell, wherein:
the cartridge comprises at least two chambers;
one chamber stores the fuel; and
the other chamber stores the oxidizer.
